(19) United States
(12) Patent Application Publication
(10) Pub. No.: US 2024/0345793 A1
(43) Pub. Date: Oct. 17, 2024

(54) Content Display Method, Device, Apparatus, Medium and Vehicle

(71) Applicant: Bayerische Motoren Werke Aktiengesellschaft, Muenchen (DE)

(72) Inventors: Jochen BURGERMEISTER, Muenchen (DE); Shiny JIANG, Shanghai (CN); Felix PRASCHAK, Shanghai (CN); Thoralf REIS, Muenchen (DE); Benoit SAUTS, Blaustein (DE)

(21) Appl. No.: 18/683,371

(22) PCT Filed: Aug. 9, 2022
(86) PCT No.: PCT/EP2022/072323

§ 371 Date: Feb. 13, 2024

(30) Foreign Application Priority Data
Aug. 18, 2021 (CN) 202110950081.1

(51) Int. Cl. G06F 3/14

(52) U.S. Cl. CPC G06F 3/1454

(57) ABSTRACT

A content display method, an apparatus, a device, a readable storage medium, and a vehicle are provided. The method is for an in-vehicle electronic device associated with an external electronic device. The method includes: obtaining content to be rendered, the content to be rendered including content data that is for display on the external electronic device and associated with an application program running on the external electronic device; rendering the content to be rendered based on a display capability of a display unit of the in-vehicle electronic device; and displaying the rendered content on the display unit.

### TECHNICAL FIELD

The present disclosure relates to the fields of smart devices, and more specifically, to a content display method, an apparatus, a device, a readable storage medium, and a vehicle.

### BACKGROUND

With the rapid development of the field of smart devices, a rapid spread of smart devices (e.g., smart phones, wearable devices, and in-vehicle smart devices) has been achieved, and these smart devices can implement increasingly rich functions. However, due to the barriers of different operating systems, manufacturers, and third-party application programs, the interconnectivity between these smart devices still needs to be improved.

The methods described in this section are not necessarily methods that have been previously conceived or employed. It should not be assumed that any of the methods described in this section is considered to be the prior art just because they are included in this section, unless otherwise indicated expressly. Similarly, the problem mentioned in this section should not be considered to be universally recognized in any prior art, unless otherwise indicated expressly.

### SUMMARY

It would be advantageous to provide a mechanism that mitigates, alleviates or even eliminates one or more of the above-mentioned problems.

According to an aspect of the present disclosure, there is provided a content display method for an in-vehicle electronic device. The in-vehicle electronic device is associated with an external electronic device. The method includes: obtaining content to be rendered, the content to be rendered including content data that is for display on the external electronic device and associated with an application program running on the external electronic device; rendering the content to be rendered based on a display capability of a display unit of the in-vehicle electronic device; and displaying the rendered content on the display unit.

According to another aspect of the present disclosure, there is provided a content display apparatus for an in-vehicle electronic device. The in-vehicle electronic device is associated with an external electronic device. The apparatus includes: a first module configured to obtain content to be rendered, the content to be rendered including content data that is for display on the external electronic device and associated with an application program running on the external electronic device; a second module configured to render the content to be rendered based on a display capability of a display unit of the in-vehicle electronic device; and a third module configured to display the rendered content on the display unit.

According to yet another aspect of the present disclosure, there is provided an in-vehicle electronic device. The device includes a display unit; a memory; a processor; and a computer program stored on the memory, where the processor is configured to execute the computer program to implement steps of the content display method described above.

According to yet another aspect of the present disclosure, there is provided a non-transitory compute readable storage medium having a computer program stored thereon, where the computer program, when executed by a processor having a display unit, implements steps of the content display method described above.

According to yet another aspect of the present disclosure, there is provided a computer program, where the computer program, when executed by a processor having a display unit, implements steps of the content display method described above.

According to yet another aspect of the present disclosure, there is provided a vehicle including the apparatus described above or the in-vehicle electronic device described above.

These and other aspects of the present disclosure will be clear from the embodiments described below, and will be clarified with reference to the embodiments described below.

### BRIEF DESCRIPTION OF THE DRAWINGS

The drawings exemplarily show embodiments and form a part of the specification, and are used to illustrate example implementations of the embodiments together with a written description of the specification. The embodiments shown are merely for illustrative purposes and do not limit the scope of the claims. Throughout the drawings, like reference signs denote like but not necessarily identical elements.

FIG. 1 is a schematic diagram showing an application scenario according to an example embodiment;

FIG. 2 is a flowchart showing a content display method for an in-vehicle electronic device according to an example embodiment;

FIG. 3 is a flowchart showing a content display method for an in-vehicle electronic device according to an example embodiment;

FIG. 4 is a structural block diagram showing a content display apparatus for an in-vehicle electronic device according to an example embodiment;

FIG. 5 is a structural block diagram showing a content display apparatus for an in-vehicle electronic device according to an example embodiment; and

FIG. 6 is a structural block diagram showing an example in-vehicle electronic device that can be used to implement one or more example embodiments.

### DETAILED DESCRIPTION OF THE EMBODIMENTS

In the present disclosure, unless otherwise specified, the use of the terms “first”, “second”, etc. to describe various elements is not intended to limit the positional relationship, timing relationship, or importance relationship of these elements. Such terms are only used for distinguishing one element from another. In some examples, the first element and the second element may refer to the same instance of the element, and in some cases, based on the description of the context, they may also refer to different instances.

The terms used in the description of the various examples in this disclosure are only for the purpose of describing specific examples, and are not intended to be limiting. Unless the context clearly indicates otherwise, if the number of elements is not specifically limited, there may be one or more elements. As used herein, the term “plurality” means two or more, and the term “based on” should be interpreted as “based at least in part.” In addition, the terms “and/or” and “at least one of” cover any one of the listed items and all possible combinations.

It should be understood that the term “vehicle” or other similar terms used herein generally includes motor vehicles such as passenger vehicles including cars, sport utility vehicles (SUVs), buses, large trucks, and various commercial vehicles, and includes all kinds of boats, ships, aircraft, etc., and further includes hybrid vehicles, electric vehicles, plug-in hybrid electric vehicles, hydrogen-powered vehicles and other alternative fuel vehicles (for example, sources other than petroleum fuel).

As used herein, the phrase “vehicle-mounted/in-vehicle system” refers to an integrated information system with information processing capabilities. These systems are sometimes referred to as in-vehicle information systems, and are often integrated with communication services, in-vehicle sensors, entertainment systems, and/or navigation systems.

In the related art, the content display method for in-vehicle electronic devices may only support obtaining content of limited forms from a smart phone paired with an in-vehicle electronic device and displaying it on a display unit of the in-vehicle electronic device. The in-vehicle electronic device, for example, may only support obtaining and displaying address book information, call information, Short Message Service (SMS) information, etc., of the paired smart phone. Since the content that may be obtained and displayed is very limited, the in-vehicle electronic device may not create a good user experience for the driver or passengers.

Embodiments of the present disclosure provide a content display method for an in-vehicle electronic device. According to an embodiment of the present disclosure, by obtaining content data for display on an external electronic device and associated with an application program running on the external electronic device, the in-vehicle electronic device is able to obtain, for example, application notification information of the message center and application content data (such as, text, audio, image, video, etc.) of the application program. The obtained content is then rendered and displayed based on the display capability of a display unit of the in-vehicle electronic device. In this way, the visualization of the content data of the application program of the external electronic device is realized by the in-vehicle electronic device, thereby improving the richness of the content rendered and displayed by the in-vehicle electronic device, and enhancing the driver and passengers' user experience of the in-vehicle electronic device.

Hereinafter, example embodiments of the present disclosure will be described in detail with reference to the drawings.

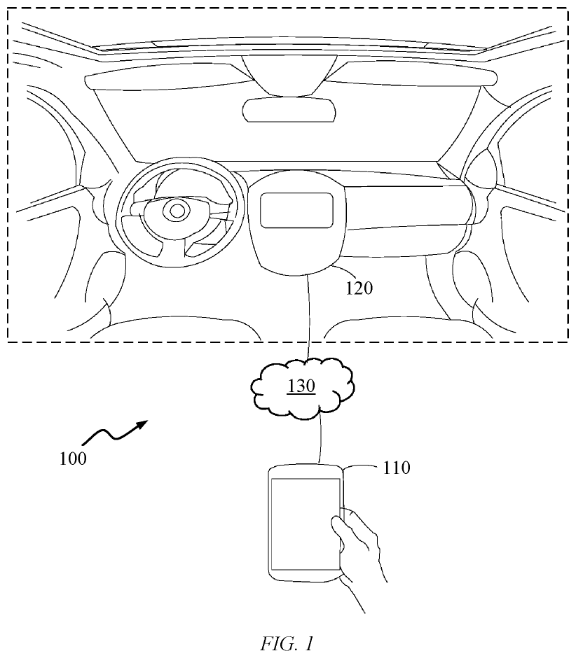

FIG. 1 is a schematic diagram showing an application scenario 100 according to an example embodiment. The application scenario 100 may include a mobile device 110 and an in-vehicle system 120, wherein the mobile device 110 and the in-vehicle system 120 may be connected through a network 130 (such as a wired network and/or a wireless network).

The mobile device 110 is usually a mobile device held by the driver of the vehicle or other users in the vehicle, including but not limited to a smart phone, a mobile phone, a tablet computer, etc., for example.

The in-vehicle system 120 is an integrated information system with information processing capabilities, as mentioned above. The in-vehicle system 120 usually provides some commonly used functions, such as media playback, radio, navigation, and reversing camera.

The user may interact with the in-vehicle system 120 through the mobile device 110, or may directly interact with the in-vehicle system 120, for example, through gesture request input, voice request input, physical key request input, and/or virtual key request input. In some example embodiments, the physical keys may include physical buttons, switches, levers, knobs and other physical manipulable keys in the vehicle, and the virtual keys may include, for example, virtual buttons, switches, levers, knobs and other virtual manipulable keys on the touch screen in the car, which are not limited herein.

The application scenario 100 may also include a server and one or more communication networks that couple the mobile device 110 and the in-vehicle system 120 to the server (the server and the communication network is not shown in FIG. 1). The server may send content for display to the mobile device 110 and the in-vehicle system 120.

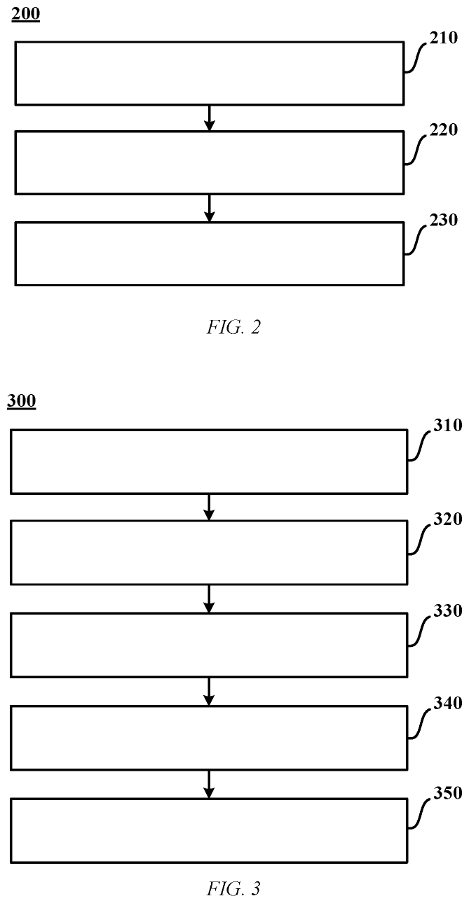

FIG. 2 is a flowchart illustrating a content display method 200 for an in-vehicle electronic device according to an example embodiment. The method 200 may be executed in an in-vehicle electronic device (for example, the in-vehicle system 120 shown in FIG. 1).

According to some embodiments, the in-vehicle electronic device and the external electronic device are associated with each other. The external electronic device may include, for example, a smart phone and/or a smart tablet computer. In some example embodiments, the display unit of the in-vehicle electronic device may include, for example, various display screens in a vehicle, such as a central display, a dashboard display, a head-up display (HUD), and one or more headrest displays, which are not limited herein. The in-vehicle electronic device may also include other information collecting units, such as a camera unit for collecting gesture instructions, a voice collecting unit for collecting voice instructions, and a physical key unit for collecting physical key instructions, which are not limited herein.

Referring to FIG. 2, at step 210, content to be rendered is obtained.

According to some embodiments, the content to be rendered includes content data associated with an application program running on an external electronic device. As a result, the in-vehicle electronic device may obtain richer content including, for example, text, audio, image, video and other content of the application program, as well as notification message associated with the application program, thereby enhancing the user-friendliness of in-vehicle electronic device. Different from directly projecting the screen display content of the external electronic device rendered by the external electronic device to the in-vehicle electronic device for display, in the embodiments of the present application, the content to be rendered obtained by the in-vehicle electronic device is the content data specific to application programs, rather than the screen display data of the external electronic device. Such application program-specific content data can be rendered (including, for example, tailored, curated, etc.) by the in-vehicle electronic device to make the rendered content more suitable for the in-vehicle display system, as will be further described later.

According to some embodiments, the in-vehicle electronic device is communicatively connected with the external electronic device. Obtaining the content to be rendered, for example, may include directly obtaining the content to be rendered from the external electronic device, the content to be rendered being the content data associated with the application program and for display during foreground running of the application program. Therefore, by directly connecting the in-vehicle electronic device with the external electronic device, the content data of the application program on the external electronic device may be directly sent to the in-vehicle electronic device, and then rendered and displayed by the in-vehicle electronic device. In an example embodiment, the in-vehicle electronic device may be connected with the external electronic device via Bluetooth or Wi-Fi, and the content data of the application program may be transmitted based on a corresponding Socket protocol. It is understandable that those skilled in the art may alternatively use other communication methods to connect the in-vehicle electronic device to the external electronic device, and may use other protocols to transmit the content data, which is not limited herein.

According to some embodiments, the content data, as the content to be rendered, associated with the application program and for display during the foreground running of the application program, may include, for example, content such as text, audio, image, and video displayed in the application or any combination thereof, which is not limited herein.

According to some embodiments, the in-vehicle electronic device may be registered with a service associated with the external electronic device to support the in-vehicle electronic device to obtain the content to be rendered from a server of the external electronic device. Obtaining the content to be rendered may include, for example, obtaining the content to be rendered from the server of the external electronic device, the content to be rendered being the content data associated with the application program and for display during background running of the application program. Therefore, the in-vehicle electronic device may obtain the content data of the application program for display on the external electronic device without directly communicating with the external electronic device, thereby further improving the user experience of the in-vehicle electronic device.

According to some embodiments, the content data, as the content to be rendered, associated with the application program and for display during the background running of the application program, may include, for example, notification messages sent by a system application program of the external electronic device, such as, an alarm message, a timer message, a low battery message, etc. The content data may also include various notification messages of third-party applications, for example, new message notification messages of instant messaging applications, new video update notification messages of video applications, and repayment notification messages of payment applications. It is understandable that this type of content may also be displayed even when the application is not running under certain circumstances, and it may still be treated and used as content to be rendered for display on the in-vehicle electronic device, which is not limited herein.

In an example embodiment, the content data of the application from the external electronic device may be transmitted to the in-vehicle electronic device via a communication connection between the external electronic device and the in-vehicle electronic device, and the content data of the application from the server of the external electronic device may be transmitted to both the in-vehicle electronic device and the external electronic device with a registered service by the server synchronously.

At step 220, the content to be rendered is rendered based on the display capability of a display unit of the in-vehicle electronic device.

According to some embodiments, the display capability of the display unit may include at least one selected from the group consisting of a type, a shape, a resolution, a pixel pitch, and a refresh rate of the display unit. As mentioned above, the display unit may include, for example, a central display, a dashboard display, a head-up displays (HUD), or a headrest display. Typically, the dashboard display and the head-up display have low display capabilities. For example, the head-up display may only display content in white, monochromatic colors, or only a few colors, so as to minimize the obstruction of the driver's field of vision. The central display is usually a touch screen display or a display that can be controlled by physical keys such as a knob, and has a high display capability. Therefore, for different types of display units, different rendering needs to be performed for the content to be rendered. Similarly, for different display units with different shapes, resolutions, pixel pitches, and refresh rates, it is necessary to perform different rendering for the content to be rendered to obtain better display effects.

At step 230, the rendered content is displayed on the display unit.

To sum up, by obtaining, at the in-vehicle electronic device, content data for display on the external electronic device and associated with the application program running on the external electronic device, the richness of the content rendered by and displayed on the in-vehicle electronic device is improved, and the user experience for drivers and passengers is enhanced.

FIG. 3 shows a flowchart of a content display method 300 for an in-vehicle electronic device according to other example embodiments of the present disclosure. Referring to FIG. 3, the method 300 includes step 310 to step 350.

At step 310, the content to be rendered is obtained. The operation of step 310 in FIG. 3 is similar to the operation of step 210 in FIG. 2, and will not be repeated herein.

At step 320, a display unit for displaying the rendered content is determined from a plurality of display units.

According to some embodiments, as described above, the in-vehicle electronic device may include multiple display units. In this case, before rendering and displaying the content to be rendered, the display unit for displaying the rendered content may be determined first. In an example embodiment, the determination may be made according to the type of content to be rendered. For example, when the content to be rendered is the content of navigation applications or map applications, the content may be displayed on the dashboard display and/or HUD; when the content to be rendered is the content of video applications, news applications, and other applications that are not related to driving, the content may be displayed on the central display. In another example embodiment, the determination may be made based on the location of the passenger. For example, when the passenger is in the co-pilot seat, the content may be displayed on the central display; when the passenger is in the backseat behind the co-pilot seat, the content may be displayed on the headrest display of the co-pilot seat; when there are multiple passengers in the vehicle, the content may also be displayed on multiple screens simultaneously. It can be understood that those skilled in the art may also determine the display unit for display by other means, which is not limited herein.

At step 330, the content to be rendered is rendered based on the capability of the display unit of the display electronic device. The operation of step 330 in FIG. 3 is similar to the operation of step 220 in FIG. 2 and will not be repeated herein.

At step 340, the rendered content is displayed on the display unit. The operation of step 340 in FIG. 3 is similar to the operation of step 230 in FIG. 2, and will not be repeated herein.

At step 350, in response to receiving the user request, at least one of the operations is performed: executing a specified function in the application program; and displaying specified content in the application program.

According to some embodiments, after the in-vehicle electronic device receives the user request, the user request may be sent to the external electronic device, thereby realizing the interaction between the user, the in-vehicle electronic device, and the external electronic device. In some example embodiments, the user request may include executing a specified function in a specified application and/or displaying specified content in a specified application. In an example embodiment, the specified application is a music application, and the user may make a user request for executing a “switch to the next song” operation. After receiving this request, the in-vehicle electronic device can send the request to the external electronic device. After receiving this request, the music application of the external electronic device carries out the switching operation, and sends content data related to the next song to the in-vehicle electronic device. As a result, the user can instruct the execution of specific functions of the application on the external electronic device and the display of the specified content in the application via the in-vehicle electronic device, thereby enhancing the interaction between the user, the in-vehicle electronic device, and the external electronic device, and improving the user experience of in-vehicle electronic device.

According to some embodiments, the user request includes at least one selected from the group consisting of a gesture request, a voice request, a physical key request, and a virtual key request. As mentioned above, the physical keys may include, for example, physical manipulable keys such as buttons, switches, levers, knobs, etc., in the vehicle, and the virtual keys may include, for example, virtual buttons, switches, levers, knobs, etc. on the touch screen of the vehicle, which are not limited herein. It is understandable that those skilled in the art may set up various above-mentioned requests to realize the user's control of the content displayed on the in-vehicle electronic device, which is not limited herein.

According to some embodiments, the user may also control the content display on the in-vehicle electronic device via the external electronic device. In an example embodiment, the user can specify content to be displayed on a specific display unit of the in-vehicle electronic device via the external electronic device, and the external electronic device can send the content to the in-vehicle electronic device for display.

To sum up, by using the above method, the interaction between the user, the in-vehicle electronic device and the external electronic device is realized, and the user experience of the driver and the passenger is further enhanced.

FIG. 4 shows a schematic block diagram of a content display apparatus 400 for an in-vehicle electronic device according to an example embodiment.

According to some embodiments, the in-vehicle electronic device is associated with an external electronic device. Referring to FIG. 4, the apparatus 400 includes: a first module 410 configured to obtain content to be rendered, the content to be rendered including content data that is for display on the external electronic device and associated with an application program running on the external electronic device; a second module 420 configured to obtain render the content to be rendered based on a display capability of a display unit of the in-vehicle electronic device; and the third module 430 configured to display the rendered content on the display unit.

According to some embodiments, the in-vehicle electronic device is communicatively connected with the external electronic device. The first module 410 is further configured to obtain, as the content to be rendered, directly from the external electronic device content data for display during foreground running of the application program and associated with the application program.

According to some embodiments, the in-vehicle electronic device is registered with a service associated with the external electronic device to support the in-vehicle electronic device to obtain the content to be rendered from a server of the external electronic device. The first module 410 is further configured to obtain, as the content to be rendered, from the server of the external electronic device content data for display during background running of the application program and associated with the application program.

It should be understood that each module of the apparatus 400 shown in FIG. 4 may correspond to each step in the method 200 described above with reference to FIG. 2. Therefore, the operations, features, and advantages described above for the method 200 are also applicable to the apparatus 400 and the modules included in it. For the sake of brevity, some operations, features and advantages will not be repeated herein.

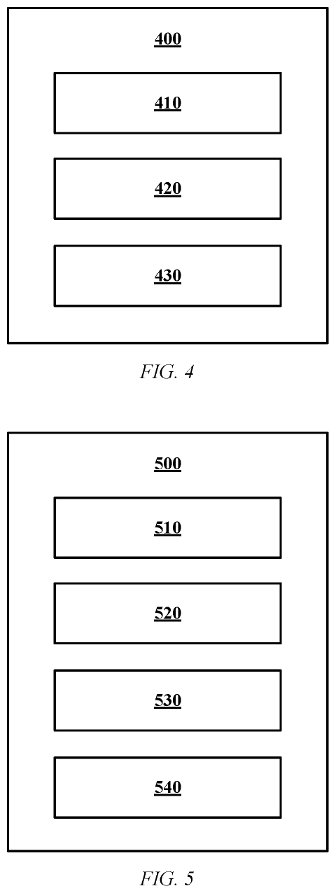

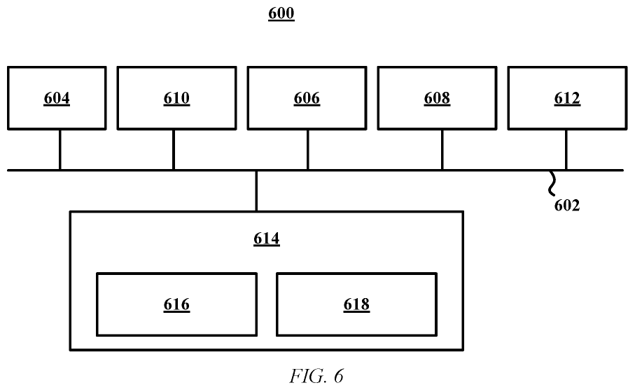

FIG. 5 shows a block diagram of a content display apparatus 500 for an in-vehicle electronic device according to other example embodiments of the present disclosure.

According to some embodiments, the in-vehicle electronic device includes a plurality of display units. Compared with the apparatus 400 in FIG. 4, the device 500 further includes: a fourth module 540, configured to determine, from the plurality of display units, the display unit for displaying the rendered content. The operations of modules 510 to 530 in the apparatus 500 are respectively similar to the operations of modules 410 to 430 in the apparatus 400, and will not be repeated herein.

Although specific functions have been discussed above with reference to specific modules, it should be noted that the functions of each module discussed herein may be divided into multiple modules, and/or at least some functions of multiple modules may be combined into a single module. The specific module execution action discussed herein includes the specific module itself performing the action, or alternatively the specific module calls or otherwise accesses another component or module that performs the action (or performs the action in conjunction with the specific module). Therefore, a specific module that performs an action may include the specific module itself that performs an action and/or another module that is called or accessed by the specific module to perform an action.

It should also be understood that various techniques may be described herein in the general context of software hardware elements or program modules. The various modules described above with respect to FIG. 5 may be implemented in hardware or in hardware combined with software and/or firmware. For example, these modules may be implemented as computer program codes/instructions configured to be executed in one or more processors and stored in a computer-readable storage medium. Alternatively, these modules can be implemented as hardware logic/circuitry. For example, in some embodiments, one or more of the above-mentioned various modules may be implemented together in a system on chip (SoC). The SoC may include an integrated circuit chip (which includes a processor (for example, a central processing unit (CPU), a microcontroller, a microprocessor, a digital signal processor (DSP), etc.), a memory, one or more communication interfaces, and/or one or more components in other circuits), and can optionally execute the received program code and/or include embedded firmware to perform functions.

According to an aspect of the present disclosure, there is provided an in-vehicle electronic device including: a display unit; a memory; a processor; and a computer program stored on the memory, wherein the processor is configured to execute the computer program to implement the above-described steps of any method embodiment.

According to an aspect of the present disclosure, there is provided a non-transitory computer-readable storage medium on which a computer program is stored, and when the computer program is executed by a processor, the steps of any method embodiment described above are implemented.

According to an aspect of the present disclosure, there is provided a computer program product, which includes a computer program that, when executed by a processor, implements the steps of any method embodiment described above.

According to an aspect of the present disclosure, there is provided a vehicle including any apparatus described above or any in-vehicle electronic device described above.

In the following, illustrative examples of such in-vehicle electronic devices, non-transitory computer-readable storage medium, and computer program products are described in conjunction with FIG. 6.

FIG. 6 shows an example configuration of an in-vehicle electronic device 600 that can be used to implement the methods described herein.

The in-vehicle electronic device 600 may be any machine configured to perform processing and/or calculations, and may be, but is not limited to, a workstation, a server, a desktop computer, a laptop computer, a tablet computer, a personal digital assistant, a smart phone, an in-vehicle computer, or any combination thereof. The above-mentioned content display apparatus and in-vehicle electronic device may be fully or at least partially implemented by the in-vehicle electronic equipment 600 or similar devices or systems.

The in-vehicle electronic device 600 may include elements connected to or communicating with the bus 602 (possibly via one or more interfaces). For example, the in-vehicle electronic device 600 may include a bus 602, one or more processors 604, one or more input devices 606, and one or more output devices 608. The one or more processors 604 may be any type of processor, and may include, but are not limited to, one or more general-purpose processors and/or one or more special-purpose processors (for example, special processing chips). The input device 606 may be any type of device that can input information to the in-vehicle electronic device 600, and may include, but is not limited to, a mouse, a keyboard, a touch screen, a microphone, and/or a remote control. The output device 608 may be any type of device capable of presenting information, and may include, but is not limited to, a display, a speaker, a video/audio output terminal, a vibrator, and/or a printer. The in-vehicle electronic device 600 may also include a non-transitory storage device 610 or be connected to a non-transitory storage device 610. The non-transitory storage device may be any storage device that is non-transitory and can realize data storage, and may include, but is not limited to, disk drives, optical storage devices, solid-state storage, floppy disks, flexible disks, hard disks, tapes or any other magnetic media, optical disc or any other optical media, ROM (read only memory), RAM (random access memory), cache memory and/or any other memory chip or cartridge, and/or any other medium from which the computer can read data, instructions and/or code. The non-transitory storage device 610 can be detached from the interface. The non-transitory storage device 610 may have data/programs (including instructions)/code for implementing the above-mentioned methods and steps. The in-vehicle electronic device 600 may also include a communication device 612. The communication device 612 may be any type of device or system that enables communication with external devices and/or with the network, and may include, but is not limited to, a modem, a network card, an infrared communication device, a wireless communication device, and/or a chipset, such as Bluetooth™ device, 1302.11 device, WiFi device, WiMax device, cellular communication device, and/or the like.

When the in-vehicle electronic device 600 is used as an in-vehicle system, the in-vehicle electronic device 600 can also be connected to external devices, such as a GPS receiver, sensors for sensing different environmental data (such as acceleration sensors, wheel speed sensors, gyroscopes), and many more. In this way, the in-vehicle electronic device 600 can, for example, receive position data and sensor data indicating the driving condition of the vehicle. When the in-vehicle electronic device 600 is used as an in-vehicle system, the in-vehicle electronic device 600 may also be connected to other facilities (such as an engine system, a wiper, an anti-lock brake system, etc.) for controlling the running and operation of the vehicle.

In addition, the non-transitory storage device 610 may have map information and software elements so that the processor 604 can perform route guidance processing. In addition, the output device 606 may include a display for displaying a map, a location mark of the vehicle, and an image indicating the driving condition of the vehicle. The output device 606 may also include a speaker or interface with headphones for audio guidance.

The bus 602 may include, but is not limited to, an industry standard architecture (ISA) bus, a microchannel architecture (MCA) bus, an enhanced ISA (EISA) bus, a Video Electronics Standards Association (VESA) local bus, and a peripheral component interconnect (PCI) bus. Specifically, for an in-vehicle system, the bus 602 may include a controller area network (CAN) bus or other architectures designed for applications on automobiles.

The in-vehicle electronic device 600 may also include a work memory 614, which may be any type of work memory that can store programs (including instructions) and/or data useful for the work of the processor 604, and may include, but is not limited to, random access memory and/or read-only memory device.

The software elements (programs) may be located in the working memory 614, including but not limited to the operating system 616, one or more application programs 618, drivers, and/or other data and codes. Instructions for executing the above methods and steps may be included in one or more application programs 618, and each module of the above-mentioned in-vehicle content display device may be implemented by the processor 604 reading and executing instructions of one or more application programs 618. The executable code or source code of the instructions of the software element (program) can be stored in a non-transitory computer-readable storage medium (for example, the aforementioned storage device 610), and can be stored in the working memory 614 during execution (may be compiled And/or installation). The executable code or source code of the instructions of the software element (program) can also be downloaded from a remote location.

It should also be understood that various modifications can be made according to specific requirements. For example, customized hardware may also be used, and/or specific elements may be implemented using hardware, software, firmware, middleware, microcode, hardware description language, or any combination thereof. For example, some or all of the disclosed methods and devices can be implemented by programming hardware (for example, programmable logic circuits including Field Programmable Gate Array (FPGA) and/or Programmable Logic Array (PLA)) in assembly language or hardware programming language (such as VERILOG, VHDL, C++) using logic and algorithms according to the present disclosure.

It should also be understood that the foregoing method can be implemented in a server-client mode. For example, the client can receive data input by the user and send the data to the server. The client can also receive the data input by the user, perform part of the processing in the foregoing method, and send the data obtained by the processing to the server. The server can receive data from the client, execute the foregoing method or another part of the foregoing method, and return the execution result to the client. The client may receive the execution result of the method from the server, and may present it to the user through an output device, for example.

It should also be understood that the name of the in-vehicle electronic device 600 is not intended to limit that the device is completely located in the vehicle. The components of the in-vehicle electronic device 600 may be distributed on a network. For example, one processor may be used to perform some processing, while at the same time another processor far away from the one processor may perform other processing. Other components of the in-vehicle electronic device 600 can also be similarly distributed. In this way, the in-vehicle electronic device 600 can be interpreted as a distributed computing system that performs processing in multiple locations.

Although the embodiments or examples of the present disclosure have been described with reference to the accompanying drawings, it should be understood that the above-mentioned methods, systems, and devices are merely example embodiments, and the scope of the present disclosure is not limited by these embodiments or examples, but is only limited by the authorized claims and their equivalent scope. Various elements in the embodiments or examples may be omitted or may be replaced by equivalent elements. In addition, the steps may be performed in an order different from that described in the present disclosure. Further, various elements in the embodiments or examples can be combined in various ways. What is important is that as technology evolves, many elements described herein can be replaced by equivalent elements appearing after this disclosure.

1. A content display method for an in-vehicle electronic device, the in-vehicle electronic device being associated with an external electronic device, the method comprising:
obtaining content to be rendered, the content to be rendered comprising content data that is for display on the external electronic device and associated with an application program running on the external electronic device;
rendering the content to be rendered based on a display capability of a display unit of the in-vehicle electronic device; and
displaying the rendered content on the display unit.

2. The method of claim 1, wherein the in-vehicle electronic device is communicatively connected with the external electronic device, and wherein the obtaining the content to be rendered comprises:
obtaining, as the content to be rendered, directly from the external electronic device content data for display during foreground running of the application program and associated with the application program.

3. The method of claim 1, wherein the in-vehicle electronic device is registered with a service associated with the external electronic device to support the in-vehicle electronic device to obtain the content to be rendered from a server of the external electronic device, and wherein the obtaining the content to be rendered comprises:
obtaining, as the content to be rendered, from the server of the external electronic device content data for display during background running of the application program and associated with the application program.

4. The method of claim 1, wherein the in-vehicle device comprises a plurality of display units, and wherein the method further comprises:
determining from the plurality of display units the display unit for displaying the rendered content.

5. The method of claim 2, further comprising:
in response to receiving a user request, performing at least one operation selected from a group consisting of:
executing a specified function of the application program; and
displaying specified content of the application program.

6. The method of claim 5, wherein the user request comprises at least one selected from a group consisting of:
a gesture request, a voice request, a physical key request, and a virtual key request.

7. The method of claim 1, wherein the display capability of the display unit comprises at least one selected from a group consisting of:
a type, a shape, a resolution, a pixel pitch, and a refresh rate of the display unit.

8. The method of claim 1, wherein the external electronic device comprises one selected from a group consisting of:
a smart phone and a smart tablet computer.

9. A content display apparatus for an in-vehicle electronic device, the in-vehicle electronic device being associated with an external electronic device, the apparatus comprising:
a first module configured to obtain content to be rendered, the content to be rendered comprising content data that is for display on the external electronic device and associated with an application program running on the external electronic device;
a second module configured to render the content to be rendered based on a display capability of a display unit of the in-vehicle electronic device; and
a third module configured to display the rendered content on the display unit.

10. The apparatus of claim 9, wherein
the in-vehicle electronic device is communicatively connected with the external electronic device, and
the second module is further configured to obtain, as the content to be rendered, directly from the external electronic device content data for display during foreground running of the application program and associated with the application program.

11. The apparatus of claim 9, wherein
the in-vehicle electronic device is registered with a service associated with the external electronic device to support the in-vehicle electronic device to obtain the content to be rendered from a server of the external electronic device, and
the first module is further configured to obtain, as the content to be rendered, from the server of the external electronic device content data for display during background running of the application program and associated with the application program.

12. An in-vehicle electronic device comprising:
a display unit;
a memory;
a processor; and
a computer program stored on the memory,
wherein the processor is configured to execute the computer program to carry out the acts of:
obtaining content to be rendered, the content to be rendered comprising content data that is for display on the external electronic device and associated with an application program running on the external electronic device;
rendering the content to be rendered based on a display capability of a display unit of the in-vehicle electronic device; and
displaying the rendered content on the display unit.

13. A computer product comprising a non-transitory computer readable storage medium having a computer program stored thereon, wherein the computer program, when executed by a processor having a display unit, carries out the acts of:
obtaining content to be rendered, the content to be rendered comprising content data that is for display on the external electronic device and associated with an application program running on the external electronic device;
rendering the content to be rendered based on a display capability of a display unit of the in-vehicle electronic device; and
displaying the rendered content on the display unit.

14. (canceled)

15. A vehicle comprising the apparatus of claim 9.

16. A vehicle comprising the in-vehicle electronic device of claim 12.
